(19) United States
(12) Patent Application Publication
(10) Pub. No.: US 2005/0209904 A1
(43) Pub. Date: Sep. 22, 2005

(54) Program for managing workflow and workflow support system

(75) Inventor: Shoichi Hayashi, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 10/942,767

(22) Filed: Sep. 17, 2004

(30) Foreign Application Priority Data
Mar. 17, 2004 (JP) 2004-077235

(51) Int. Cl. G06F 17/60

(52) U.S. Cl. 705/9; 705/26

(57) ABSTRACT

A workflow management device which cooperates with an electronic bulletin board is disclosed. The workflow management device includes a request target designation unit which accepts a designation of a request target of an activity in a workflow and having a function to accept a designation of an electronic bulletin board as a request target of the activity, and a bulletin board posting unit which posts, when the request target designation unit designates an electronic bulletin board as a request target of an activity, to the electronic bulletin board, an activity request message containing a link to data of the activity in the workflow.

### BACKGROUND OF THE INVENTION

1. Field of the Invention

The present invention relates to a system for managing workflow.

2. Description of the Related Art

Conventionally, various tools and systems for managing workflow based on information technology are provided by various suppliers. As use of such tools has become widespread, an organization known as the Workflow Management Coalition (“WfMC”) has been organized to encourage standardization of tools. According to the WfMC definition, “workflow” is “the automation of a business process, in whole or part, during which documents, information or tasks are passed from one participant to another for action, according to a set of procedural rules”. WfMC also defines a “workflow management system” as “a system that defines, creates and manages the execution of workflows through the use of software, running on one or more workflow engines, which is able to interpret the process definition, interact with workflow participants and, where required, invoke the use of IT tools and applications”. An individual work performed by a worker in a workflow is commonly called an “activity” (or, sometimes, just a “task”). In other words, the workflow is defined with a series of activities.

In a conventional workflow management system, generally, a participant who executes individual activity is designated by the name of an individual or the post of the individual. There are many systems which are configured such that, in order to prevent clogging of work when the designated participant is absent, the participant is automatically changed to a substitute who is set in advance as an exception process when a work fails under certain conditions.

However, in such a system, it is necessary to precisely analyze various possible exceptions in advance and to define responses for these exceptions. While the precise analysis may be possible for routine works, when a system is to be constructed which can be applied to a field containing various elements which is difficult to be formed into a routine such as office work, consideration of all possible exceptions is nearly impossible, and, even when possible, very inefficient.

For this purpose, for example, Japanese Patent Laid-Open Publication No. Hei 8-101817 discloses a system in which a user forms rules regarding known conditions and way of work around the user and the workflow is controlled based on these rules so that the flow smoothly flows without precise designation of the substitute during an exception of activity. This reference also discloses a structure in which, when the flow is clogged even after all of the rules have been applied, an activity within the flow which is designated in advance is back-tracked and the system prompts a user interface of the participant of the activity for a response.

Japanese Patent Laid-Open Publication No. Hei 10-214113 discloses a system which allows each participant in the workflow to refer to related data created by a participant upstream of the work flow, before the flow comes to the participant's work. In this system, content of all data items related to a sequence of work processes are gathered and stored in an electronic bulletin board database and all participants of related work share the data in a form of a bulletin board through a client machine.

Japanese Patent Laid-Open Publication No. 2000-322340 discloses a system for providing an electronic bulletin board controller which can emulate the workflow of a work, efficiently, easily, and reliably manage electronic mails, automatically perform designation of a referrer, verification of reference, and posting of update notification in a unit of mails or attachment files, and reliably notify or exchange information of articles, in an electronic bulletin board system on a WWW server.

A significant selling point of a workflow management system is how the system can flexibly respond to various exceptions. The system of the related art described above attempt to realize a smooth flow of a workflow through various methods.

However, in typical workflow management system in the related art, functions are provided presuming management of business processes based on European or American systems and the workflow management system may not always conform with management of business processes of a type preferred in Japan and spread throughout the world.

Specifically, the workflow management system of the related art generally designates the participant of an activity by an individual person or role, and applies a similar method to designation of a response to an exception. In management preferred in, for example, Japan, however, it is more common for individual members of a team (such as division or the like) to have overlapping roles than for the team members to have roles strictly distributed among the individual members. In addition, in general, the distribution of the work within the team is determined situationally rather than in a top-down manner, in a process, for example, wherein the members of the team consult with each other. In a workplace culture with such a system of management, the method of designating the participant and/or substitute of an activity with an individual or a role is not always efficient.

Although the systems of related art described above provide flexibility to the workflow with various methods, these systems were insufficient from the viewpoint of consideration of a workplace culture in which the participant is determined according to the atmosphere of a situation. For example, although the system of Japanese Patent Laid-Open Publication No. Hei 8-101817 provides a flexibility by performing a flow control on a rule-basis and the system of Japanese Patent Laid-Open Publication No. Hei 10-214113 improves flexibility by providing an environment in which the activity can be executed in advance, both of these systems do not differ from a typical system of related art regarding designation of a participant and a substitute to which the activity is requested (hereinafter also referred to as “request target”). The system of Japanese Patent Laid-Open Publication No. 2000-322340 is primarily directed to emulating a workflow of the related art using an electronic bulletin board system and does not differ from the system of the related art regarding designation of a participant and a substitute to which the activity is requested.

### SUMMARY OF THE INVENTION

According to one aspect of the present invention, there is provided a program for allowing a computer system to function as a workflow management device for managing execution of a workflow having multiple activities, wherein the program allows the computer system to function as a request target designation unit which accepts a designation or a change of a request target of an activity in the workflow and which has a function to accept a designation in which an electronic bulletin board is designated as a request target of the activity and a bulletin board posting unit which posts, to an electronic bulletin board, when the request target designation unit designates an electronic bulletin board as a request target of an activity, an activity request message including links to management information and input content data of the activity in the workflow.

### BRIEF DESCRIPTION OF THE DRAWINGS

Preferred embodiment(s) of the present invention will be described in detail based on the following figures, wherein:

FIG. 1 is a diagram for explaining an overall structure of a system according to a preferred embodiment of the present invention;

FIG. 2 is a diagram for explaining a setting screen of a workflow and activity;

FIG. 3 is a diagram for explaining a request target setting screen;

FIG. 4 is a diagram for explaining a designation screen of a response method when a bulletin board is designated as a request target;

FIG. 5 is a diagram showing an example of a work list display screen;

FIG. 6 is a diagram showing an example of an electronic bulletin board display screen provided by an electronic bulletin board system; and

FIG. 7 is a diagram showing an example of a request target setting screen corresponding to a detailed request target designation within a bulletin board.

### DESCRIPTION OF PREFERRED EMBODIMENTS

Preferred embodiments of the present invention (hereinafter simply referred to as “embodiments”) will now be described referring to the drawings.

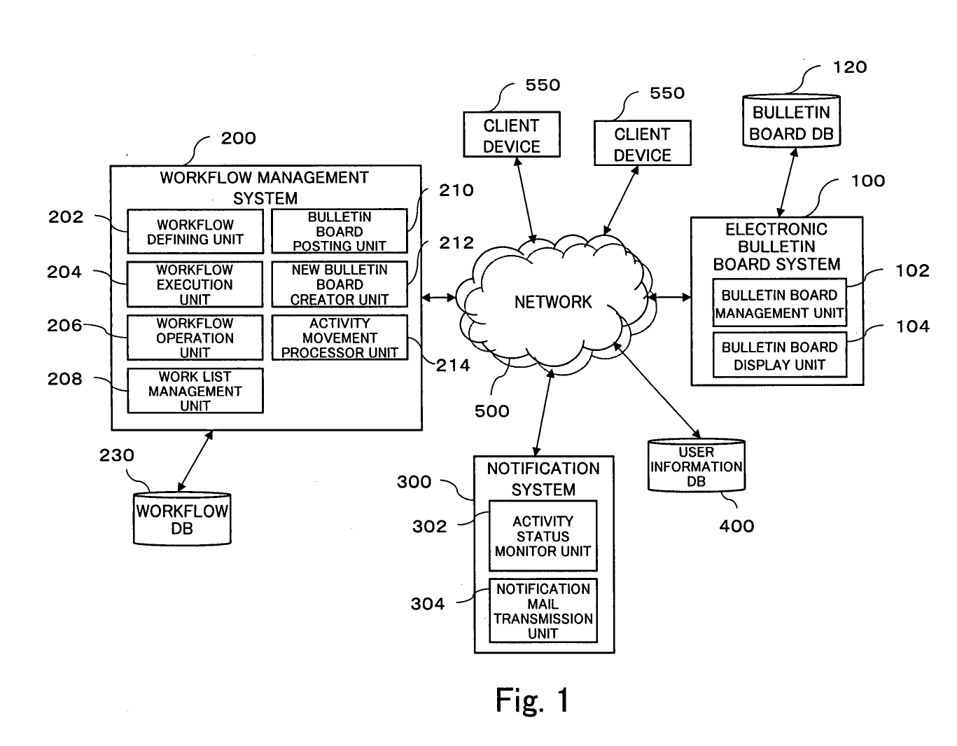

First, an overall structure of a workflow support system according to the present invention will be described referring to FIG. 1.

A workflow support system includes a workflow management system 200, an electronic bulletin board system 100, a notification system 300, and a user information database (hereinafter simply referred to as “DB”) 400 which are interconnected through a network 500 such as the Internet and a LAN (Local Area Network) within a company, as its primary constituents.

The workflow support system is applied to an organization in which individual users belonging to the organization are registered such as in a company or a company group. As workflows dynamically connecting various companies on the Internet are expected to be spread, the workflow support system is not limited to existing closed organizations and may also be applied to an organization that may be openly and dynamically formed.

Users belonging to the organization for which the system is provided are registered in the user information DB 400. The user information DB 400 may be made public or may be managed distributed in separate multiple databases. The user information DB 400 stores, for each user, information such as, for example, an ID of the user (identification information which allows unique specification of an individual such as an employee number), a name of the user, a post of the user, a division to which the user belongs, etc. The user information stored in the user information DB 400 is suitably referred to by the electronic bulletin board system 100 and the workflow management system 200. Alternatively, it is also possible to employ a configuration in which authentication information of each user (such as a password) used for user authentication at the electronic bulletin board system 100 and workflow management system 200 is stored in the user information DB 400 and to perform authentication by these systems suitably accessing the DB 400.

The electronic bulletin board system 100 which forms a part of the workflow support system has a “member registration” structure which basically does not allow posting (also referred to as submission or message registration) or viewing by an anonymous person. Specifically, for each electronic bulletin board (hereinafter also simply referred to as “bulletin board”) managed by the electronic bulletin board system 100, a list of members who access the bulletin board is managed. Only a user registered in the user information DB 400 can access each bulletin board.

A bulletin board management unit 102 performs management regarding electronic bulletin boards. The bulletin board management unit 102 performs access management of each user with respect to each bulletin board based on user authentication and processes a request for viewing or registering a message (posting) to a bulletin board from a user who is determined by the bulletin board management unit 102 as having an authority as a result of the authentication. The bulletin board management unit 102 also has a function to create a new bulletin board or to register a new member to a bulletin board in response to a request by a user.

Information related to each electronic bulletin board managed by the bulletin board management unit 102 is stored in a bulletin board DB 120. The bulletin board DB 120 stores, for each bulletin board, a list of messages posted in the bulletin board and a list of members registered for the bulletin board. The list of messages form the main body of the electronic bulletin board, and a data format typically used in the related art can be used. The list of the members may be, in the simplest form, a list of user IDs of the members. Information such as the name and post of the user can be obtained from the user information DB 400 as necessary (alternatively, it is also possible to allow all of such information for each member to be stored in the bulletin board DB 120). In addition, it is also possible to assign roles to each member in individual electronic bulletin board. In this configuration, the list of members also includes information on the roles of each member. The role is different from the post assigned to the user in the organization. Roles of members of the bulletin board include, for example, a leader who administers discussions and communications in the bulletin board, a member who is a typical member who views messages or posts messages to the bulletin board, and an observer who is only allowed to view the bulletin board. These roles are only exemplary, and other roles may be set or other classification of roles seen from another viewpoint may alternatively be employed.

A bulletin board display unit 104 is a functional module for displaying an electronic bulletin board to a user in response to a request from the user. The bulletin board display unit 104 provides the electronic bulletin board requested by a user through a client device 550 (which may be, for example, a personal computer and a web browser), for example, in a form of a WWW (World Wide Web) web page to a client device 550.

The electronic bulletin board system 100 provides electronic bulletin boards as a place of information sharing or discussion to users within the organization. A user opens a bulletin board in the system 100 as necessary, for pursuing business of the organization or performing efforts related to the business, gathers his colleagues for the efforts (that is, the members of the bulletin board), and proceeds with efforts such as discussion. When the bulletin board is applied to a company effort, the bulletin board functions as a place of virtual communication for the effort related to the business. Such a “place” can be provided independent of the existing organizational structure such as a division and post. The “place” also is an entity on a data communication network, and thus, it is easier to make or terminate the place compared to forming a team in the actual workplace. Therefore, such a configuration is suitable for a business environment which demands speed.

Therefore, the individual bulletin board managed by the electronic bulletin board system 100 may be considered as a group of users who have common business or interest within the organization. In each bulletin board which is opened, a title of the bulletin board is set by the originator or the members and is stored in the bulletin board DB 120 by the bulletin board management unit 102. By employing a configuration of operation in which a title indicating the content of the effort is assigned as the title of the bulletin board, it is possible for each user in the organization to view a list of titles of bulletin boards that are opened and to know an overview of an effort to which a community existing in the organization is related. In addition to the title of the bulletin board, by storing a description of the bulletin board targeted to people outside of the community associated with the bulletin board and publishing the description, the content of the efforts related to each bulletin board can be more easily understood. This description may be provided, for example, in a form of a web page.

From another viewpoint, the electronic bulletin board system 100 may be considered as a mechanism for a groupware to provide a dedicated electronic bulletin board to individual group. In this configuration, the electronic bulletin board system 100 is one of the services that make up the groupware. Therefore, in this configuration in which the electronic bulletin board system 100 is provided as a part of the groupware, it is possible to provide not only a bulletin board service to the members of the bulletin board, but also services typically provided by a groupware such as schedule management and document sharing.

A workflow management system 200 of the present embodiment has functional modules of a workflow defining unit 202, a workflow execution unit 204, a work flow operation unit 206, a work list management unit 208, a bulletin board posting unit 210, a new bulletin board creator unit 212, and an activity movement processor unit 214.

The workflow defining unit 202 is a functional module for accepting an input of a definition of a workflow from a user. The definition of the workflow is performed in the workflow management system also in the related art and the workflow defining unit 202 can basically use commonly available tools for defining a workflow in the related art. A user can access the workflow defining unit 202 from the client device 550, create a workflow definition, and store the workflow definition. The created workflow definition is stored in a workflow DB 230 as a template and is used. That is, when a user selects and starts a workflow definition, a workflow instance which is an individual specific workflow is created and is executed by a workflow execution unit 204. The workflow instance is an object for storing and executing procedures (and/or rules) and data for controlling a workflow. As the workflow execution unit 204, a typical workflow engine of the related art can be used as the basic portion.

The workflow DB 230 also stores information on an individual workflow instance in addition to the workflow definition.

The workflow operation unit 206 is a functional module for accepting an operation to start a workflow or an operation to a workflow instance which is being executed. The operations to the workflow instance include a designation and a change of a request target of an activity in the instance. A user can access the workflow operation unit 206 from the client device 550 and to apply operations to the workflow instance. The basic portion of the workflow operation unit 206 may be formed using the workflow operation unit used in a workflow management system of the related art, similar to the workflow execution unit 204 described above.

The work list management unit 208 creates a work list of each user based on information of workflows which are being executed by the workflow execution unit 204 and provides, to a user, the work list for the user in response to a request from the user using the client device 550. The worklist is a list which lists activities that are to be executed by the user at that point, and is sometimes also referred to as a “to-do” list. On a display of each activity shown in the work list, a link is provided to an object of the activity managed by the workflow execution unit 204. Therefore, when a user selects an activity that the user wishes to execute on the work list displayed on the client device 550, the user can execute processes to the activity. Similar to the above-described structures, the basic portion of the work list management unit 208 may be formed using a typical work list management unit used in a workflow management system of the related art.

As described, it is possible to use structures of the related art for the basic structure for workflow management in the system according to the present embodiment. A characteristic added to the basic structure is that it is possible to designate an individual bulletin board managed by the electronic bulletin board system 100 as a request target of individual activities of the workflow. Specifically, in the workflow management system of the related art, typically, a specific individual person or post was designated as a request target of an activity, whereas, in the present embodiment, in addition to an individual person and post, it is possible to designate a bulletin board managed by the electronic bulletin board system 100. As described, because a bulletin board corresponds to a community (group) of people performing a specific effort within the organization, this configuration corresponds to designation of a community as the request target of an activity. This configuration, however, differs from a simple designation of a group formed of multiple users as the request target. Specifically, in a simple designation of a group as the request target, when it is not determined how the activity (work) is to be distributed within the group, the users forming the group must talk to each other in person or by sending electronic mails to each other to determine the distribution of work. In contrast, when the electronic bulletin board is designated as a request target, there is an advantage that the bulletin board which is already in existence can be used as a place of discussing the distribution of the work. In some cases, a new member may be invited as a result of discussion on the bulletin board, and that person may become a participant.

As opportunities for designating or changing a request target of an activity in the workflow, in general, three opportunities are present, a first being when a workflow is defined by the workflow definition unit 202; a second being when the workflow is started (that is, when a workflow instance is created); and a third being when the workflow instance is being executed (for example, when a person who executed a certain activity designates a request target of the next activity, etc.). Among the three opportunities, in the latter two opportunities, the designation and change of request target of activity is performed through the workflow operation unit 206. The present embodiment is configured to allow an electronic bulletin board to be designated as a request target during a designation or change of request target in addition to an individual person and post as was possible in the related art.

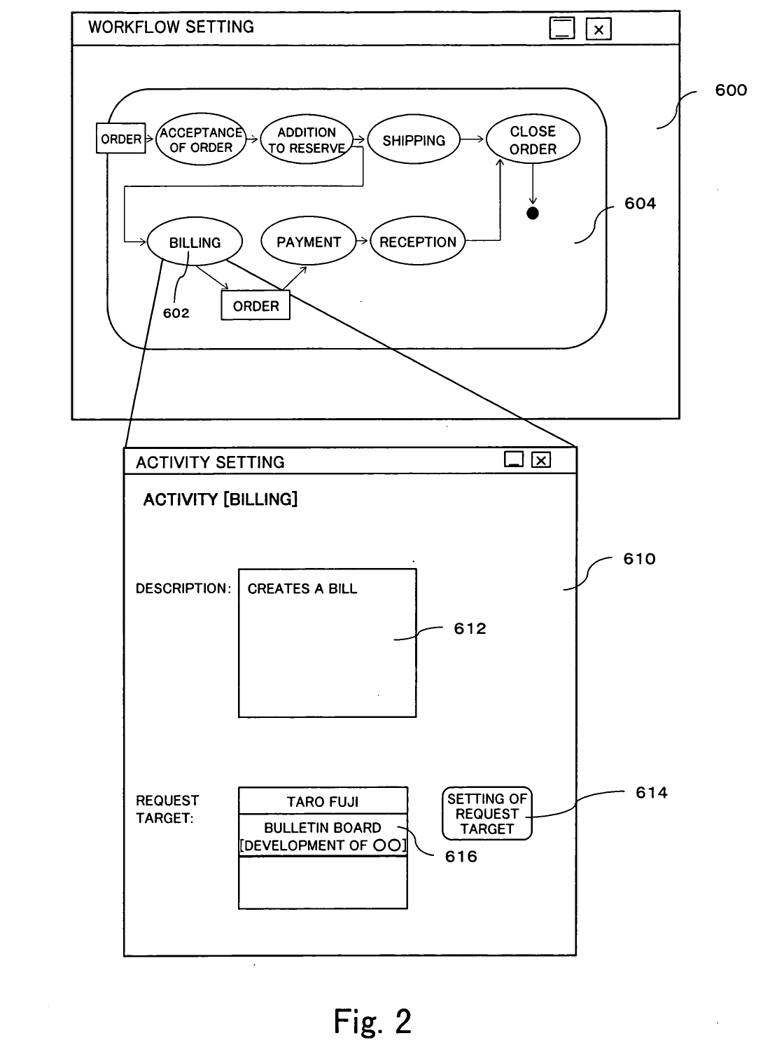

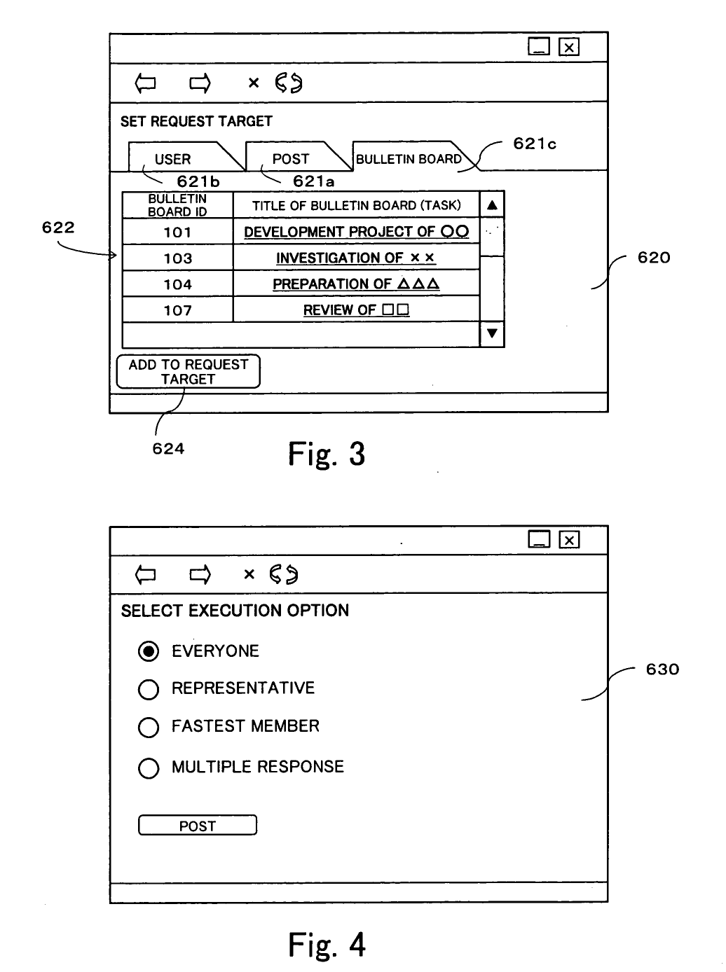

FIG. 2 shows an example of a setting screen for a workflow and activity provided by the workflow defining unit 202 and the workflow operation unit 206. A workflow setting screen 600 shows a workflow 604 in which activities 602 are arranged according to the sequence of the processes and the order in the sequences are indicated by arrows. When a workflow is to be defined, a network flow can be defined by arranging activities and designating an order of execution on the workflow setting screen 600. By selecting an activity 602 in the workflow through, for example, a double click operation on a mouse, it is possible to call an activity setting screen 610 for setting a content of the activity. In the illustrated configuration, the activity setting screen 610 shows a description column 612 and a request target list 616. In an actual setting of the content of activity, additional designations such as a designation of an application to be invoked and a document to be created. The illustrated configuration, however, are simplified for avoiding complication of the illustration. In the description column 612, a description of a content of the activity for the request target is input, for example, by the defining user of the workflow. The request target list 616 shows at least one person, role, or electronic bulletin board designated as the request target of the activity. The input of the request target to the request target list 616 is realized by, for example, selecting a candidate list display button 614 to call a request target setting screen 620 as shown in FIG. 3.

In the request target setting screen 620, a list of individual users, a list of posts, and a list of electronic bulletin boards can be displayed on the screen by respectively selecting a tab 621a, a tab 621b, and a tab 621c. In this description, a display example when a bulletin board list 622 is displayed will be described. The bulletin board list 622 lists IDs and titles of bulletin boards which can be selected as a request target. Information in this bulletin board list is obtained from the electronic bulletin board system 100. It is also desirable to add links, to the titles of bulletin boards in the list, for example, descriptions of bulletin boards stored in the electronic bulletin board system 100 and to allow the user to call the description. By selecting a bulletin board from the bulletin board list 622 by clicking a mouse or other means and selecting an “add to a request target” button 624, the corresponding bulletin board can be added to the request target list 616. Similar processes may be applied in a case in which an individual user or a post is designated as the request target.

It is also desirable to additionally allow designation of what methodology is to be used for responding to what activity, with respect to a bulletin board, when the bulletin board is designated as a request target. FIG. 4 shows an example of a designation screen 630 of response methodology of bulletin board. In the illustrated configuration, four response methodology of “everyone”, “representative”, “fastest member”, and “multiple response” are shown. The response methodology of “everyone” indicates that the activity is to be processed by every member of the bulletin board designated as the request target. When this methodology is selected, the activity in the workflow instance is completed by all of the members of the bulletin board performing the processing of the activity. The response methodology of “representative” indicates that one member determined through discussion among the members of the bulletin board processes the activity. The response methodology of “fastest member” indicates that the activity is to be processed by the fastest answering member of the bulletin board, and, when this methodology is selected, the activity is completed by one of the members of the bulletin board processing the activity. The response methodology of “multiple response” is a methodology which allows for multiple members of the bulletin board to process the activity. When this methodology is selected, processing of the activity by a member of the bulletin board is accepted until some completion condition of the activity which is separately designated is satisfied, such as, for example, expiration of a designated activity limitation time.

When a response methodology to the activity is designated as described, the workflow execution unit 204 accepts processes to the activity by the members of the bulletin board according to the designated methodology and determines completion of the activity.

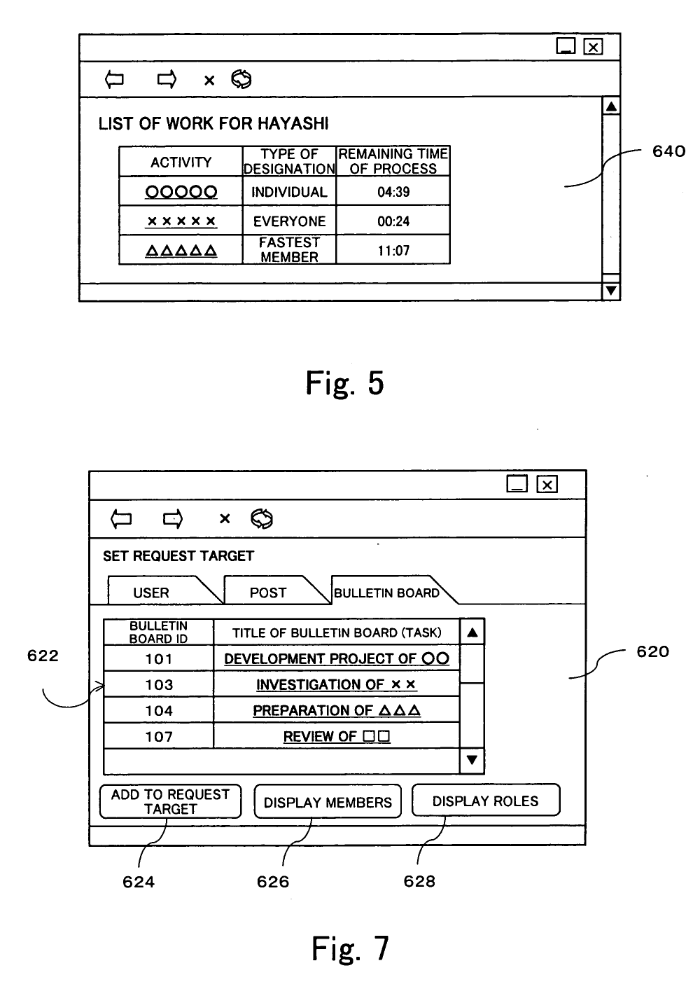

When a structure is employed in which a response methodology is designated for an activity to be covered by the bulletin board, it is desirable to also display the response methodology designated to each activity in the work list. FIG. 5 shows an example of such a work list display screen 640. In the illustrated configuration, activities that should be performed by a user whose name is “Hayashi” is shown along with a type of designation of the response methodology. Here, the designation type of “individual” is a type in which a user is designated as the request target by designating the name of the individual person or post similar to the related art. The designation types of “everyone” and “fastest member” correspond to types when the bulletin board is designated as a request target. The user can determine whether the execution request of the activity is addressed to the user as an individual person or addressed to the bulletin board of which he is a member. In addition, the user can determine, in the activities addressed to the bulletin board, whether or not a certain activity must be processed by the user, and thus, can determine an order of priority of activities.

The work list of FIG. 5 also shows the remaining time of process of the activity (in the illustrated configuration, the time is shown with hours and minutes). This remaining time indicates remaining time calculated from the limitation time set for the activity and/or designation of the completion time. The user would know by when the activities must be completed referring to the remaining time of process.

As described, a user can know, from the work list, activities in which the user is directly designated or indirectly designated through the bulletin board as the request target. In the present embodiment, in addition to this structure, information regarding activities in which the bulletin board is designated as the request target is posted and displayed in the bulletin board.

First information posted in the bulletin board regarding an activity is an activity request message which indicates that the activity is requested. The request message contains a predetermined message indicating that execution of the activity has been requested and a link to an object of the activity managed by the workflow execution unit 204. It is desirable to include, in the message, for example, a designation of the workflow instance to which the activity belongs, the title of the activity itself, and a description of the activity. However, if a link is provided, the user can directly obtain information of the activity through the link, and therefore, the inclusion of these information is not mandatory. When a bulletin board is designated as a request target of an activity by the workflow defining unit 202 or by the workflow operation unit 206, the bulletin board posting unit 210 of the workflow management system 200 posts such an activity request message to the electronic bulletin board system 100.

One timing for posting such an activity request message to the bulletin board is the point when it is time for that activity to be invoked in a workflow execution sequence. With such a configuration, the members of the bulletin board can know from the bulletin board that an activity is requested at a timing in which the activity is to be invoked. For this purpose, the bulletin board posting unit 210 obtains execution status of the workflow instance from the workflow execution unit 204, and, when the bulletin board posting unit 210 detects, from the information of the execution status, that the turn for the activity in which the bulletin board is designated as a request target has come, the bullet in board posting unit 210 posts the activity request information to the bulletin board. Because the bulletin board posting unit 210 can perform the above-described processes as long as the execution status of each workflow instance is known, the bulletin board posting unit 210 need not always be included in the workflow management system 200.

It is also possible to post a preliminary notice message to a bulletin board prior to the time for executing an activity in which the bulletin board is designated as the request target. Example timings of posting of the preliminary notice message include, for example, the time when the activity is created and the time when the status of the previous activity changes. By indicating, in the preliminary notice message, links for viewing documents or data created by the “previous activity”, it is possible for the member of the bulletin board to know the situation of the “previous activity”, which facilitates the members to respond. The timing when the preliminary notice message is to be posted to the bulletin board may be set, for example, during definition of the workflow.

It is also desirable that, when an event occurs for an activity in which a bulletin board is designated as a request target, a message indicating the occurrence of the event be posted in the bulletin board. Events regarding an activity include, for example, an event in which someone in the members of the bulletin board started to process the activity, an event in which the activity is completed, and an event in which the expiration time was reached without the activity being processed. It may also be preferable to post a notification, at a predetermined timing before the time limit (for example, one hour before the time limit), indicating that the time limit is approaching. In this case, the fact that the predetermined timing before the time limit was reached can be considered as an event. It is desirable to include links to objects of the activity also in the event notification message.

For this process, the bulletin board posting unit 210 obtains workflow execution status from the workflow execution unit 204, and, when the bulletin board posting unit 210 detects that an event has occurred for each activity posted in the bulletin board based on the workflow execution status, the bulletin board posting unit 210 posts a message indicating the occurrence of event to the bulletin board. When the electronic bulletin board system 100 supports a thread display of messages, it is desirable that the event notification message for an activity requested to the bulletin board be posted in the same message thread as the request message for the activity. With such a configuration, the members of the bulletin board can easily know the status of the activity by following the thread. It is also desirable to allow the administrator or the user of the workflow management system 200 to set which of the events, when occurred, is to be posted to the bulletin board.

When one bulletin board is designated as the request target for multiple activities in the same workflow instance, it is desirable that messages such as a request message and an event notification message for these activities be posted on the same thread. In this case, the bulletin board posting unit 210 records the correspondence between the posting of message regarding an activity and the bulletin board. When a message regarding an activity is to be posted in the electronic bulletin board system 100, the bulletin board posting unit 210 refers to the record to check whether or not a message regarding another activity belonging to the same workflow instance as that for the activity is present and posts a message on the same thread as the message regarding the “another activity” if a message is posted for the another activity. For example, when a request message for an activity is to be posted in the electronic bulletin board system 100, the bulletin board posting unit 210 may check whether or not there is a request message for another activity within the workflow instance to which the activity belongs, and, if there is, the bulletin board posting unit 210 can post a request message with a message which is posted at the earliest date as a reply destination (also referred to as a “reference destination”). When, on the other hand, a message regarding the activity other than the request message is to be posted, it is possible to post the message with the request message for the activity as the reply destination.

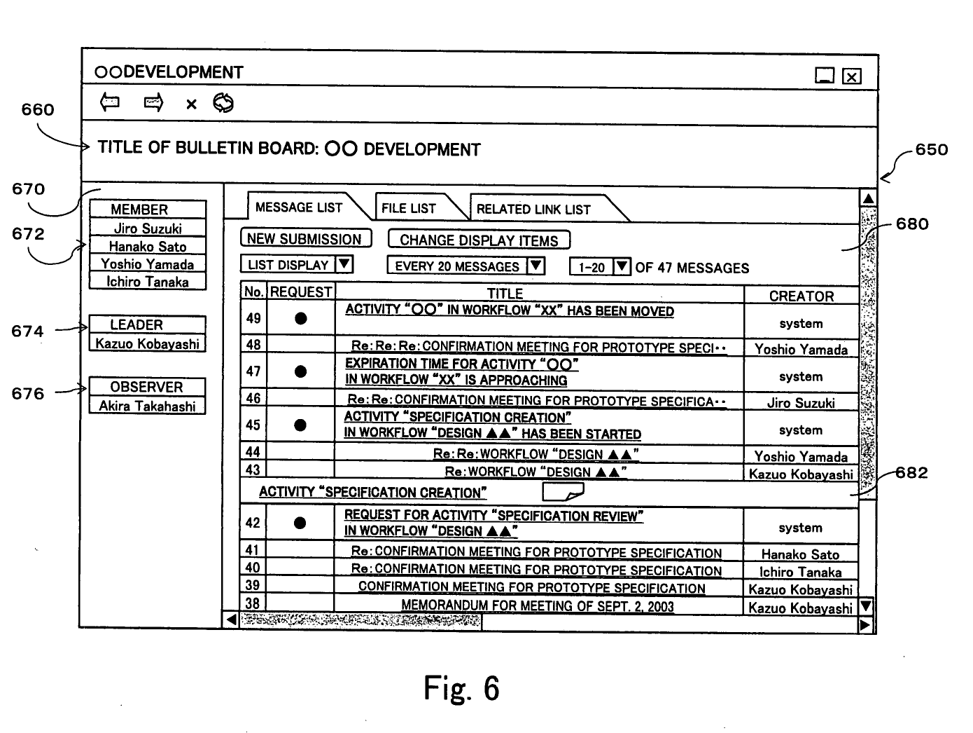

Operation of the bulletin board posting unit 210 has been described. Next, an exampled is play of an electronic bulletin board including messages posted by the bulletin board posting unit 210 will be described referring to FIG. 6.

A display screen 650 exemplified in FIG. 6 is an example screen when the screen is provided to a client device 550 as a web page and includes a title display 660, a member list display column 670, and a bulletin board display column 680. In the title display 660, the title of the bulletin board is displayed. In the member list display column 670, members of the bulletin board are displayed. In the illustrated configuration, the members are shown classified by roles in the bulletin board in a member display column 671, a leader display column 674, and an observer display column 676.

In the bulletin board display column 680, a message list is displayed in which titles of messages posted to the bulletin boards are shown. The title displayed in the list is linked to the message body so that the message body can be displayed by operations such as, for example, a click on the title. The message list exemplified in FIG. 6 displays a list of the title of the messages sorted in the time sequence of the posting time of the messages. The present invention is not limited to such a configuration and it is also possible to alternatively provide a list display screen in which the titles are displayed in a thread.

In the illustrated configuration of a list display of FIG. 6, for each message, a number indicating the order of posting (“No.”), a “request” flag indicating whether or not the message is related to an activity, a “title” of the message, and a “creator” of the message are shown. In the illustrated configuration, the messages with message numbers 42, 45, 47, and 49 relate to activities of the workflow posted by the bulletin board posting unit 210. The “request” flag for these messages shows “●” indicating that these messages relate to activities and the “creator” for these messages shows “system” indicating that these messages are automatically posted by the bulletin board posting unit 210. The form of display of the “request” flag is not limited to the illustrated form, and may be in any form which allows a user to distinguish between normal messages and activity related messages.

In the configuration illustrated in FIG. 6, the title of the workflow instance and the title of the activity are shown in the title of the activity-related messages to allow identification of the activity. In addition, a word indicating an event to be notified by the message is also shown in the title. For example, the message No. 42 corresponds to a message indicating that a certain activity is “requested” and the message No. 45 corresponds to a message indicating that someone started to work on the activity. The message No.47 corresponds to a message indicating that execution time limit of a certain activity is approaching and the message No. 49 corresponds to a message indicating that the request target of the activity has been changed from the bulletin board to another person or bullet in board (change of request target will be described later). In the body of the activity-related messages, a link to an object of the activity is included. Therefore, the user can call the message body from the title in this list and follow the link within the message body to obtain information on the requested activity or to execute the activity.

Other messages are normal messages posted by the users to the bulletin board and have the “request” flag section blank and the “creator” section filled with the user who posted the message.

Because the activity-related message is similar to the normal message in that they are both messages posted to the bulletin board, a user can post a response message designating the activity-related message as a reply destination. Message Nos. 43 and 44 in the illustrated example of FIG. 6 correspond to example messages of such a configuration.

In the configuration illustrated in FIG. 6, in order to facilitate access to the object in the requested activity, a link 682 to the object is added within the message list which shows a list of the titles. By providing a function in the electronic bulletin board system 100 to directly include a link to an object external to an electronic bulletin board within a message list, such a structure can be realized. With this structure, the user can access the entity of the activity managed by the workflow execution unit 204 by clicking on the link 682 within the message list, without clicking on the title to call the article of notification and clicking on the link within the article. The link 682 is added before or after the request article of the corresponding activity.

Referring again to FIG. 1, the notification system 300 will now be described. The notification system 300 is a system which notifies, via electronic mails, information related to activities in which a bulletin board is designated as a request target, to the members of the bulletin board. The notification system 300 has an activity status monitor unit 302 which obtains, for example, information on execution status of the workflow instances from the workflow execution unit 204, to check, from the obtained information, occurrence of any event related to an activity such as, for example, that a bulletin board is designated as a request target of a certain activity and that processing of such an activity is started. When the status monitor unit 302 determines that an activity-related event has occurred, a notification mail transmission unit 304 creates an electronic mail indicating the occurrence of the event and transmits to each member of the bulletin board. It is also desirable to include a link to an object of the activity in the notification mail. In this manner, each member of the bulletin board can be notified of occurrence of any event which is related to an activity such as a request, even when the member is not viewing the bulletin board.

Information regarding an activity-related event (including a request) may be posted also to the bulletin board. Therefore, the activity status monitor unit 302 may alternatively configured to detect occurrence of an event by monitoring each bulletin board.

The new bulletin board creator unit 212 will now be described. The new bulletin board creator unit 212 is a unit for creating a bulletin board whose members are users who are designated as a request target of an activity and registering the bulletin board in the electronic bulletin board system 100. Specifically, when only individual users or posts are designated and an electronic bulletin board is not designated as the request target of an activity, the new bulletin board creator unit 212 newly creates a bulletin board having, as its members, users corresponding to the designated individuals and posts. The new bulletin board can be used as a place of discussion regarding the activity among the people designated as the request target.

This creation of a new bulletin board may be executed when multiple people are designated as the request target. It is also possible to create a new bulletin board in a similar manner when only one person is designated as the request target. This configuration may be used for a case in which the person who is designated as the request target invites his colleagues as the members of the bulletin board for discussion.

When a new bulletin board is created in this manner, it is preferable that the notification system 300 transmits electronic mails to the members of the bulletin board notifying the creation of the bulletin board. A link to the bulletin board is included in the electronic mail.

Next, the activity movement processor unit 214 will be described. The activity movement processor unit 214 is a unit for moving, when a predetermined exception event has occurred in the activity having a bulletin board as a request target, the request target of an activity to another electronic bulletin board, that is, a unit for performing a request target moving. The exception event which triggers the request target moving is, for example, when the activity is not executed even after the designated limitation time expired, or when the members of the bulletin board explicitly input instructions indicating that the members cannot execute when the members cannot process the activity (this differs from “returning” which is one of the operations conceived in a typical workflow). The system is configured such that a bulletin board to become the moving destination (that is, a substitute participant) of the activity when the exception event occurs may be designated from the workflow definition unit 202 and the workflow operation unit 206. A screen for designating a substitute request target may be similar to the screen for designating a request target shown in FIG. 2.

When a predetermined exception event occurs regarding an activity in which a substitute request target is designated, the activity movement processor unit 214 requests the bulletin board posting unit 210 to post a request message of the activity on the bulletin board which is the substitute request target. It is desirable that, simultaneously with the posting of the request message to the substitute bulletin board, a massage is posted to the bulletin board which is the original request target, indicating that the bulletin board is no longer the participant of the activity. An example of such a message is the message No. 49 in the configuration illustrated in FIG. 6.

A change of participant within the bulletin board will now described. In the above description, it has been described that a bulletin board can be designated as a request target of an activity. However, the activity is not actually executed by the bulletin board, but by an individual member of the bulletin board. There may be cases, for example, in which, after someone in the members of the bulletin board started to work on the activity, it is found that the person cannot complete the activity or that there is a person who is more suited. For this purpose, it is desirable to provide, in the workflow management system 200, a unit for changing the executing person of the activity within the members of the bulletin board. The change of the executor may be performed using the workflow operation unit 206. That is, in this configuration, the workflow operation unit 206 provides, to the user, a screen displaying a list of executors of activities. The list display screen may be similar to the request target list of the activity setting screen 610 of FIG. 2. It is also possible to configure the system such that a list of people who is actually executing or who executed activities is displayed in a list, in addition to a list of people designated as the request target of the activity in the activity setting screen 610 itself. The system may be configured to allow selection of an executor listed in the list, to display a list of other members who may substitute with respect to the selected executor, and to accept a designation of a new request target from the list.

It is desirable that authority to change the executor be given only to people having a specific role in the bulletin board such as, for example, the leader of the bulletin board. In this configuration, the workflow operation unit 206 can obtain information of the role, in the bulletin board, of the user requesting display of the list of executors from the electronic bulletin board system 100 and can determine whether or not the user is authorized to change the executors based on the obtained information.

Detailed designation of a request target in the bulletin board will now be described.

In the above description, it has been described that a bulletin board can be designated as the activity request target. There may be a desire to allow a designation of a specific individual person or a person of specific role in the members of the bulletin board as the participant. For example, when the user who is to designate the request target knows good reputation of a certain member of the bulletin board, the user may wish to designate this member as the participant. When, on the other hand, a unified process of the activity by the bulletin board as a whole is desired, the user may prefer designation of a person of a specific role suitable for the process such as, for example, the leader of the bulletin board as the participant. In order to respond to such a demand, it is desirable that the system allows more detailed designation of request target in the bulletin board.

FIG. 7 shows an example of a request target setting screen 620 which complies with such a detailed designation. The example illustrated in FIG. 7 is a screen in which a member display button 626 and a role display button 628 are added to the request target setting screen 620 shown in FIG. 3. When a user selects a bulletin board using the bulletin board list 622 on this screen and clicks on the member display button 626, the workflow defining unit 202 and the workflow operation unit 206 provide a screen displaying a list of members of the bulletin board and allow the user to designate a request target from the member list. Similarly, when a user selects a bulletin board using the bulletin board list 622 of the screen and clicks on the role display button 628, the workflow defining unit 202 and the workflow operation unit 206 provide a screen displaying a list of roles provided in the bulletin board and allow the user to designate, as the request target, a role from the list of roles.

When an individual person or a role in the bulletin board is designated as the request target of the activity, the bulletin board posting unit 210 posts a message indicating the designation to the bulletin board. In this case, the notification system 300 may transmit a notification mail only to the individual person or the people corresponding to the role designated as the request target, rather than to all members of the bulletin board.

With such a structure, it is possible to respond to the needs of the users who designate the request target of activity in a more detail manner.

When a request target is to be designated with a name of an individual person from among the members of the bulletin board, another method may be employed in which the individual is directly designated as the participant and not through the bulletin board. However, if the person is designated in a form of “the individual in the bulletin board” as in the present embodiment, it is possible to post information of the activity to the bulletin board, which allows for an advantage that an unexpected situation can be easily responded such as, for example, when the individual cannot process the activity, he can ask the other members of the bulletin board for a substitute. The authority of change of request target in this case may be given to the designated individual, or, it is also desirable to give the authority to a person with a particular role in the bulletin board such as the leader, similar to the case of a change of executor within the bulletin board as described above.

As described, according to the system of the present embodiment, because an electronic bulletin board can be designated as a request target of an activity of a workflow and designation of request target is posted on an electronic bulletin board when the electronic bulletin board is designated as a request target, members of the electronic bulletin board can determine a method of response to the activity and a suitable participant by viewing the bulletin board and through discussion. This mechanism is expected to be suitable for an environment in which distribution of work is determined based on an atmosphere of a situation in the team.

A system disclosed in Japanese Patent Laid-Open Publication No. Hei 10-214113 uses an electronic bulletin board in a workflow similar to the above-described embodiment, and a user in this system may be able to obtain various information regarding the overall work by viewing the electronic bulletin board. However, in Japanese Patent Laid-Open Publication No. Hei 10-214113, there is a cumbersome process of selecting information necessary for the user from among the information for overall work, whereas in the present embodiment, the individual activity and bulletin board are correlated in a clearer manner, and thus, a possibility of occurrence of such a problem is low.

The system of the embodiment described above can be realized by executing, on a computer or computers (the functions may be executed by a computer or distributed among separate computers), a program in which the functions are described.

In the above description, systems 100, 200, and 300 are described as respectively having function modules 102-104, function modules 202-230, and function modules 302-304. However, the distinction among the systems 100, 200, and 300 is only for description purposes. In reality, the programs for realizing the functions of the system may be present in any computer on the network 500 (that is, the function may be executed by the computer) as long as the computers can communicate with each other through the network 500. The system of the present embodiment can be applied in a case in which multiple functional modules for each individual functional module are present on the network 500 and cooperate with each other while communicating with each other.

According to another aspect of the present invention, it is preferable that the bulletin board posting unit has a function to post an event notification message to the electronic bulletin board notifying occurrence of an event when the workflow management device detects that the event has occurred regarding an activity in which the electronic bulletin board is designated as a request target.

According to another aspect of the present invention, there is provided a computer program product which allows the computer system to function as a unit which transmits an electronic mail to a member of the electronic bulletin board notifying occurrence of an event when the workflow management device detects that the event has occurred regarding an activity in which the electronic bulletin board is designated as a request target.

According to another aspect of the present invention, there is provided a computer program product which allows the computer system to function as a new bulletin board creator unit which, when the request target designation unit designates at least one individual or post as a request target of an activity, executes a process for newly creating an electronic bulletin board having, as its member, the user corresponding to the individual or post.

The entire disclosure of Japanese patent Application No. 2004-077235 filed on Mar. 17, 2004 including specification, claims, drawings and abstract is incorporated herein by reference in its entirety.

1. A computer program product embodied on one or more computer readable media, for allowing a computer system to function as a workflow management device for managing execution of a workflow including a plurality of activities, the computer program product comprising:
computer readable program code means for accepting a designation or a change of a request target of an activity in the workflow, which has a function to accept a designation of an electronic bulletin board as a request target of an activity; and
computer readable program code means for posting, to the electronic bulletin board, when the computer readable program code means for accepting a designation or a change of a request target of an activity in the workflow designates an electronic bulletin board as a request target of an activity, an activity request message containing links to management information and input content data of the activity in the workflow.

2. A computer program product according to claim 1, wherein
the computer readable program code means for accepting a designation or a change of a request target of an activity in the workflow provides a list of electronic bulletin boards that can be designated as a request target and accepts a selection of a request target from among the electronic bulletin boards indicated in the list.

3. A computer program product according to claim 1, wherein
the computer readable program code means for posting, to the electronic bulletin board, an activity request message containing links to management information and input content data of the activity in the workflow further has a function to post, to an electronic bulletin board, when the workflow management device detects that an event occurred regarding an activity in which the electronic bulletin board is designated as the request target, an event notification message notifying the occurrence of the event.

4. A computer program product according to claim 3, wherein
the computer readable program code means for posting, to the electronic bulletin board, an activity request message containing links to management information and input content data of the activity in the workflow posts the event notification message for the activity in the same thread as that of the activity request message for the activity.

5. A computer program product according to claim 1, wherein
the computer readable program code means for posting, to the electronic bulletin board, an activity request message containing links to management information and input content data of the activity in the workflow posts, when the same electronic bulletin board is designated as a request target of a different activity in the same workflow, a message corresponding to the differing activities in the same thread in the electronic bulletin board.

6. A computer program product according to claim 1, further comprising:
computer readable program code means for transmitting, when the workflow management device detected that an event occurred regarding an activity in which an electronic bulletin board is designated as a request target, an electronic mail indicated the occurrence of the event to a member of the electronic bulletin board.

7. A computer program product according to claim 1, wherein
the computer readable program code means for accepting a designation or a change of a request target of an activity in the workflow further has a function to accept a designation of a request target for an activity as a designation of at least one of an individual person or a post.

8. A computer program product according to claim 7, further comprising:
computer readable program code means for newly creating, when the computer readable program code means for accepting a designation of a change of a request target of an activity in the workflow designates at least one individual person or post as a request target of an activity, an electronic bulletin board having, as a member, a user corresponding to the individual person or post.

9. A computer program product according to claim 8, further comprising:
computer readable program code means for transmitting, when the computer readable program code means for newly creating an electronic bulletin board creates an electronic bulletin board, to the member of the electronic bulletin board, a notification containing a link to the electronic bulletin board through electronic mail.

10. A computer program product according to claim 1, further comprising:
computer readable program code means for accepting a designation of a substitute request target which substitutes for an activity when an exception event occurs during execution of the activity, which has a function to accept a designation of an electronic bulletin board as the substitute request target; and
computer readable program code means for posting, when an exception event occurs for an activity during execution of the workflow and when the computer readable program code means for accepting a designation of the substitute request target for the activity has accepted a designation of an electronic bulletin board as a substitute request target for the activity, a message, to the electronic bulletin board, containing a link to data of the activity in the workflow.

11. A computer program product according to claim 1, further comprising:
computer readable program code means for obtaining, for an electronic bulletin board which can be designated as the request target, information of a participant changing authority who has an authority to change a person who actually participates in the activity in which the electronic bulletin board is designated as the request target, and
computer readable program code means for changing, when a person who actually participates in the activity in which the electronic bulletin board is designated as the request target is specified from among the members of the electronic bulletin board, the request target of the activity to another member of the electronic bulletin board according to an instruction from the participant changing authority of the electronic bulletin board.

12. A computer program product according to claim 1, wherein
the computer readable program code means for accepting a designation or a change of a request target of an activity in the workflow provides, in addition to the list of the electronic bulletin boards, a list of members attending the electronic bulletin board to allow designation of a specific member in the electronic bulletin board as the request target of the activity.

13. A computer program product according to claim 1, wherein
the computer readable program code means for accepting a designation or a change of a request target of an activity in the workflow provides, in addition to the list of electronic bulletin boards, a list of roles in a community of the electronic bulletin board to allow designation of a specific role in the electronic bulletin board as a request target of the activity.

14. A computer program product according to claim 1, further comprising:
computer readable program code means for providing, to each user, a list of activities in which the user is involved, wherein the list contains information in which an activity in which the user is designated as a request target as an individual can be distinguished from an activity in which an electronic bulletin board of which the user is a member is designated as the request target.

15. A computer program product according to claim 1, further comprising:
computer readable program code means for providing, when the computer readable program code means for accepting a designation or a change of a request target of an activity in the workflow accepts a designation of an electronic bulletin board as a request target of an activity, a list containing, as an option for responding to the activity by the electronic bulletin board, at least one of a desire that all members of the electronic bulletin board individually respond to the activity, a desire for an unified response by the electronic bulletin board as a whole, an allowance of responses from a plurality of members among the members of the electronic bulletin board, and a desire for a response by a fastest one of the members, and for registering, as an attribute of the activity, the response selected from the list, and
computer readable program code means for determining a completion of the activity based on the attribute for response to the activity registered by the computer readable program code means for registering, as an attribute of the activity, the response selected from the list.

16. A computer program product according to claim 1, further comprising:
computer readable program code means for managing a plurality of electronic bulletin boards, wherein
the computer readable program code means for managing a plurality of electronic bulletin boards displays a message list in a form in which an activity request message posted, to the electronic bulletin board, by the computer readable program code means for posting an activity request message containing links to management information and input content data of the activity in the workflow can be distinguished from a normal message posted to the electronic bulletin board management device by a member.

17. A workflow management device comprising:
a request target designation unit which accepts a designation of a request target of an activity in a workflow and having a function to accept a designation of an electronic bulletin board as a request target of the activity, and
a bulletin board posting unit which posts, when the request target designation unit designates an electronic bulletin board as a request target of an activity, to the electronic bulletin board, an activity request message containing a link to data of the activity in the workflow.

18. A workflow management device according to claim 17, wherein
the bulletin board posting unit further has a function to post, to an electronic bulletin board, when the workflow management device detects that an event has occurred regarding an activity in which the electronic bulletin board is designated as a request target, an event notification message notifying the occurrence of the event.

19. A workflow management device according to claim 18, wherein
the bulletin board registration unit posts the event notification message for the activity in the same thread as that of the activity request message for the activity.

20. A workflow management device according to claim 17, wherein
the bulletin board registration unit posts, when the same electronic bulletin board is designated as a request target of a different activity in the same workflow, messages corresponding to the differing activities in the same thread in the electronic bulletin board.

21. A workflow management device according to claim 17, further comprising:
a new bulletin board creator unit which newly creates, when the request target designation unit designates at least one individual person or post as a request target of the activity, an electronic bulletin board having, as a member, a user corresponding to the individual person or post.

22. A workflow management device according to claim 17, further comprising:
a substitute designation unit which accepts a designation of a substitute request target which substitutes for an activity when an exception event occurs during execution of the activity, which has a function to accept a designation of an electronic bulletin board as the substitute request target; and
a request target moving unit which posts, when an exception event occurs for an activity during execution of the workflow and when the substitute designation unit has accepted a designation of an electronic bulletin board as the substitute request target for the activity, a message, to the electronic bulletin board, containing a link to data of the activity in the workflow.

23. A workflow management device according to claim 17, further comprising:
an obtaining unit which obtains, for an electronic bulletin board which can be designated as the request target, information of a participant changing authority who has an authority to change a person who actually participates in the activity in which the electronic bulletin board is designated as the request target; and
a changing unit which changes, when a person who actually participates in an activity in which the electronic bulletin board is designated as the request target is specified from among the members of the electronic bulletin board, the request target of the activity to another member of the electronic bulletin board according to an instruction from the participant changing authority of the electronic bulletin board.

24. A workflow management device according to claim 17, further comprising:
an activity list providing unit which provides, to each user, a list of activities in which the user is involved, wherein the list contains information in which an activity in which the user is designated as a request target as an individual can be distinguished from an activity in which an electronic bullet in board of which the user is a member is designated as the request target.

25. A workflow management device according to claim 17, further comprising:
a response method designation unit which provides, when the request target designation unit accepts a designation of an electronic bulletin board as a request target of an activity, a list containing, as an option for responding to the activity by the electronic bulletin board, at least one of a desire that all members of the electronic bulletin board individually respond to the activity, a desire for an unified response by the electronic bulletin board as a whole, an allowance of responses from a plurality of members among the members of the electronic bulletin board, and a desire for a response by a fastest one of the members, and which resisters, as an attribute of the activity, the method of response selected from the list; and
a completion determining unit for determining a completion of the activity based on the attribute for response method to the activity registered by the response method designation unit.

26. A workflow management device according to claim 17, further comprising:
an electronic bulletin board managing unit which manages a plurality of electronic bulletin boards, wherein
the electronic bulletin board managing unit displays a message list in a form in which an activity request message posted by the bulletin board positing unit can be distinguished from a normal message posted to the electronic bulletin board managing unit by a member.

27. A method for managing a workflow executed by a workflow management device, the method comprising the steps of:
accepting a designation of a request target of an activity in a workflow, wherein a designation of an electronic bulletin board as the request target of the activity is accepted, and
posting, when an electronic bulletin board is designated as a request target of an activity, to the electronic bulletin board, an activity request message containing a link to data of the activity in the workflow.

28. A method for managing workflow according to claim 27, wherein
the step of posting, to the electronic bulletin board, an activity request message containing links to management information and input content data of the activity in the workflow comprises a substep of posting, to an electronic bulletin board, when the workflow management device detects that an event occurred regarding an activity in which the electronic bulletin board is designated as the request target, an event notification message notifying the occurrence of the event.

29. A method for managing workflow according to claim 27, wherein
the step of posting, to the electronic bulletin board, an activity request message containing links to management information and input content data of the activity in the workflow comprises a substep of posting the event notification message for the activity in the same thread as that of the activity request message for the activity.

30. A method for managing workflow according to claim 27, wherein
the step of posting, to the electronic bulletin board, an activity request message containing links to management information and input content data of the activity in the workflow comprises the substep of posting, when the same electronic bulletin board is designated as a request target of a different activity in the same workflow, a message corresponding to the differing activities in the same thread in the electronic bulletin board.

31. A method for managing workflow according to claim 27, further comprising the step of:
newly creating, when at least one individual person or post is designated as a request target of an activity in the step of accepting a designation or a change of a request target of an activity in the workflow, an electronic bulletin board having, as a member, a user corresponding to the individual person or post.

32. A method for managing workflow according to claim 27, further comprising the steps of:
accepting a designation of a substitute request target which substitutes for an activity when an exception event occurs during execution of the activity, wherein a designation of an electronic bulletin board as the substitute request target is accepted; and
posting, when an exception event occurs for an activity during execution of the workflow and when a designation of an electronic bulletin board as a substitute request target for the activity has been accepted in the substitute request target designation step, a message, to the electronic bulletin board, containing a link to data of the activity in the workflow.

33. A method for managing workflow according to claim 27, further comprising the steps of:
obtaining, for an electronic bulletin board which can be designated as the request target, information of a participant changing authority who has an authority to change a person who actually participates in the activity in which the electronic bulletin board is designated as a request target; and
changing, when a person who actually participates in the activity in which the electronic bulletin board is designated as the request target is specified from among the members of the electronic bulletin board, the request target of the activity to another member of the electronic bulletin board according to an instruction from the participant changing authority for the electronic bulletin board.

34. A method for managing workflow according to claim 27, further comprising the step of:
providing, to each user, a list of activities in which the user is involved, wherein a list is provided containing information in which an activity in which the user is designated as a request target as an individual can be distinguished from an activity in which an electronic bulletin board of which the user is a member is designated as the request target.

35. A method for managing workflow according to claim 27, further comprising the steps of:
providing, when a designation of an electronic bulletin board is accepted as a request target of an activity in the request target designation step, a list containing, as an option for responding to the activity by the electronic bulletin board, at least one of a desire that all members of the electronic bulletin board individually respond to the activity, a desire for an unified response by the electronic bulletin board as a whole, an allowance for responses from a plurality of members among the members of the electronic bulletin board, and a desire for a response by a fastest one of the members, and of registering, as an attribute of the activity, the response method selected from the list, and
determining a completion of the activity based on the registered attribute regarding the response method to the activity.

36. A method for managing workflow according to claim 27, further comprising the step of:
displaying a message list in a form in which an activity request message posted in the bulletin board posting step can be distinguished from a normal message posted to the electronic bulletin board by a member.

37. A workflow support system comprising a workflow management device for managing a workflow and an electronic bulletin board management device for managing a plurality of electronic bulletin boards, wherein
the workflow management device comprises:
a request target designation unit which accepts a designation of a request target of an activity in a workflow and having a function to accept a designation of an electronic bulletin board as a request target of an activity; and
a bulletin board posting unit which issues, when the request target designation unit designates an electronic bulletin board as a request target of an activity, a request, to the electronic bulletin board management device, for posting, to the electronic bulletin board, an activity request message containing a link to data of the activity in the workflow.

38. A workflow support system according to claim 37, further comprising:
a member information storage unit which stores, for each electronic bulletin board managed by the electronic bulletin board management device, an electronic mail address of each member of the electronic bulletin board; and
a notification unit which transmits, when a message is posted in an electronic bulletin board in response to a request by the workflow management device, an electronic mail containing a link to the message in the electronic bulletin board to each member of the electronic bulletin board referring to the member information storage unit.

39. A workflow support system according to claim 37, wherein
the electronic bulletin board management device comprises a list display control unit which displays a message list in which a message posted to the electronic bulletin board in response to a request by the workflow management device can be distinguished from a normal message posted to the electronic bulletin board management device by a member.

40. A workflow support system according to claim 37, wherein
the electronic bulletin board management device comprises a unit for posting, when the same electronic bulletin board is designated as a request target of a different activity in the same workflow, messages corresponding to the differing activities in the same thread in the electronic bulletin board.
